(19) United States
(12) Patent Application Publication
(10) Pub. No.: US 2010/0320913 A1
(43) Pub. Date: Dec. 23, 2010

(54) LIGHT EMITTING DIODE (LED) MODULE WITH TIME DELAY FUNCTION

(76) Inventors: Long Wu, Dongguan City (CN); Jian-Fuh Chen, Dongguan City (CN); Yu-Chang Lin, Dongguan City (CN)

Correspondence Address: EGBERT LAW OFFICES, 412 MAIN STREET, 7TH FLOOR, HOUSTON, TX, 77002, US

(21) Appl. No.: 12/488,574

(22) Filed: Jun. 21, 2009

(51) Int. Cl. H05B 37/00

(52) U.S. Cl. 315/86

(57) ABSTRACT

The present invention provides a light emitting diode LED module with a time-delay lighting function, having an LED light-emitting unit on the power input circuit. The power input circuit for the LED light-emitting unit is connected with main power supply, backup power supply and backup power controller. The backup power supply and LED light-emitting unit are connected in parallel. At least two circuits are formed at the output end of the main power supply, one of which is connected with LED light-emitting unit for power supply and lighting purpose, and the other one of which is connected with the backup power supply via the backup power controller, allowing for charging/discharging of the backup power supply.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a light emitting diode (LED) module, and more particularly to an innovative module provided with time delay lighting functions.

2. Description of Related Art Including Information Disclosed Under 37 CFR 1.97 and 37 CFR 1.98

Due to advantages related to energy conservation, environmental protection and long service life, LED light is becoming a third-generation light source in lieu of traditional ones such as the incandescent lamp and second-generation lamp. However, LED light still has some shortcomings with respect to its heat radiation, light distribution and lighting control.

Although energy-saving LED recessed light has been developed in recent years, the currently available LED recessed light still lacks of time delay functions. In the case of failure of a main power supply, the lights will extinguish immediately, causing some restrictions in some occasions. Therefore, there is still room for improvement.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the LED module of the present invention, a main power supply, backup power supply and backup power controller are assembled on the power input circuit of LED light-emitting unit. The LED light-emitting unit is energized by the main power supply when the LED module is under normal operation; but when the main power supply is shut off, the electrical control unit of LED module will automatically activate the backup power supply to provide timing power supply for the LED light-emitting unit. Thus, time-delay lighting is realized to meet the actual requirements.

There are improvements brought about by this invention.

As the power panel can be replaced by virtue of the removable structure, it is possible to improve the performance of the light-emitting module and reduce the manufacturing costs with better industrial efficiency.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of the circuit of the present invention.

FIG. 2 shows a schematic view of the connection of the power panel of the present invention.

FIG. 3 shows a schematic view of the structure of the LED light panel of the present invention.

FIG. 4 shows a schematic view of a second structure of the LED light panel of the present invention.

FIG. 5 shows a schematic view of a third structure of the LED light panel of the present invention.

### DETAILED DESCRIPTION OF THE INVENTION

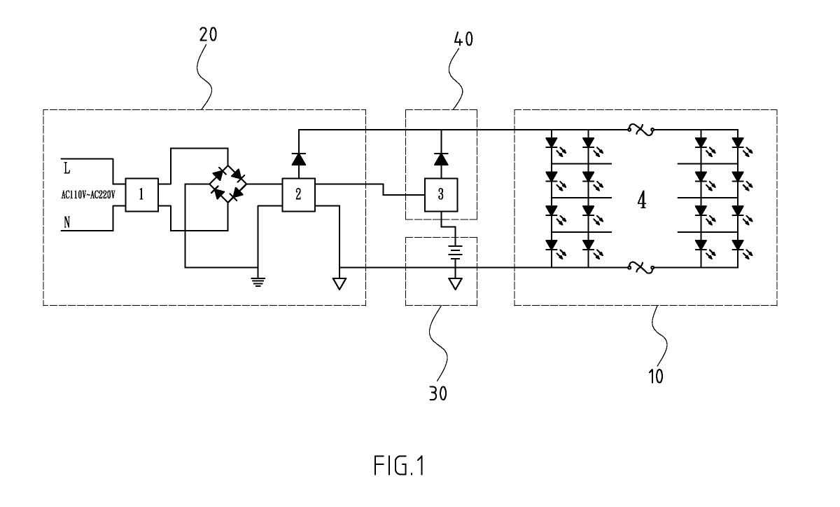

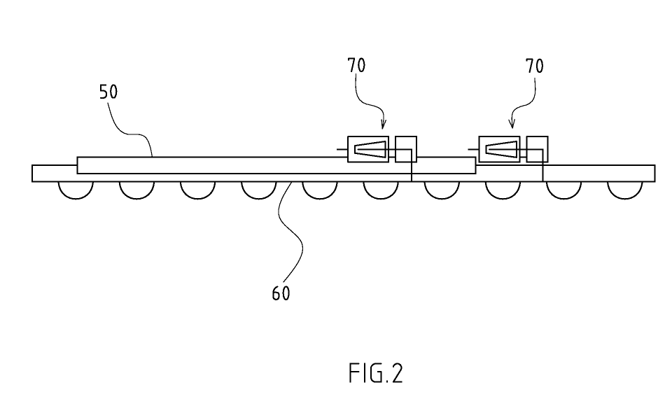

FIGS. 1-2 depict preferred embodiments of a light emitting diode (LED) module of the present invention. The embodiments are provided for only explanatory purposes with respect to the patent claims.

The LED module is provided with LED light-emitting unit 10 on the power input circuit. The power input circuit for the LED light-emitting unit 10 is connected with main power supply 20, backup power supply 30 and backup power controller 40. The backup power supply 30 and LED light-emitting unit 10 are connected in parallel. At least two circuits are formed at the output end of the main power supply 20, one of which is connected with LED light-emitting unit 10 for power supply and lighting purpose, and the other one of which is connected with the backup power supply 30 via the backup power controller 40, allowing for charging/discharging of the backup power supply 30.

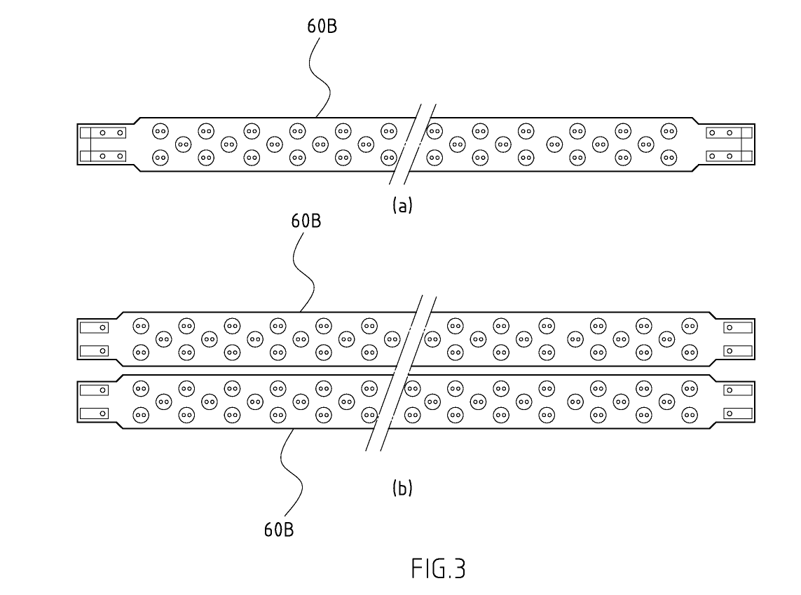

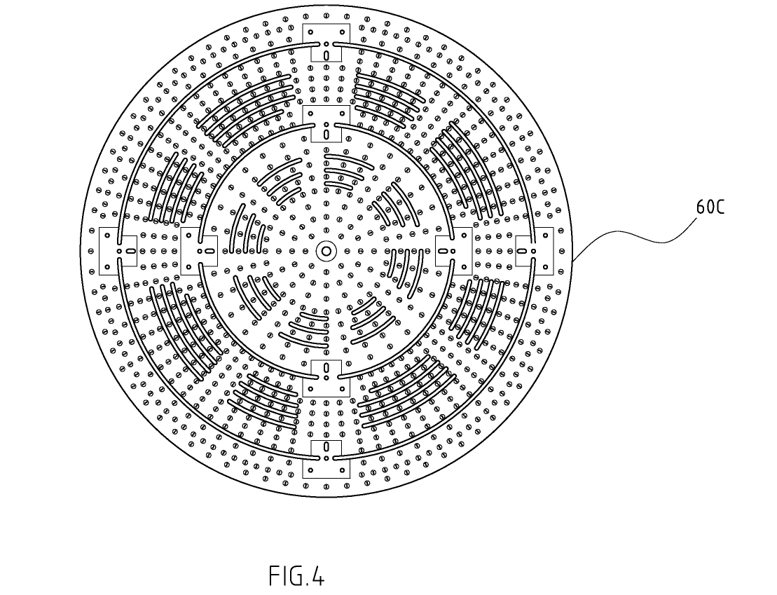

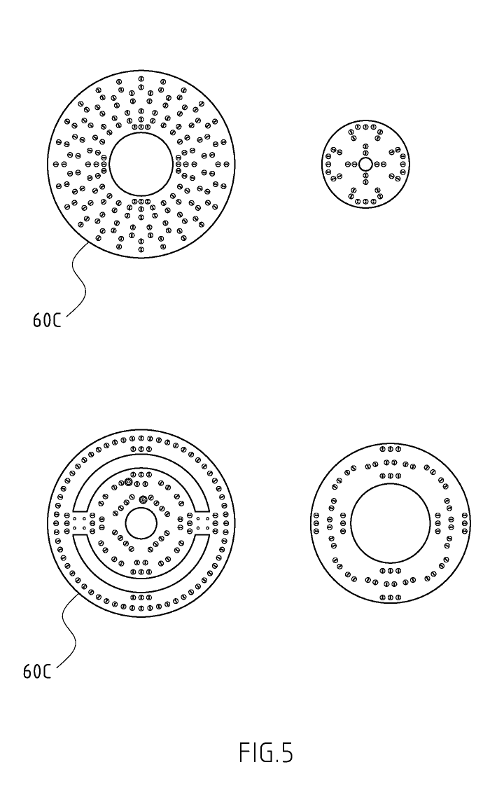

The LED light-emitting unit 10 is composed of LED light panel 60 in series or parallel connection. The LED light panel is of patterns such as long, round, oval or polygonal patterns. Referring to FIG. 3, the LED light panel 60B is of a long pattern. Referring to FIGS. 4 and 5, the LED light panel 60C is of a round pattern. The LED light panel 60B is of either a single panel structure (shown in FIG. 3(a)), or a superimposed structure (shown in FIG. 3(b)).

The main power supply 20, backup power supply 30 and backup power controller 40 are arranged on a power panel 50. The power panel 50 can be removably linked to the light-emitting module. The main power supply 20 contains an electromagnetic interference (EMI) circuit, full-bridge rectifying circuit and AC-DC control circuit, thus realizing filtering, rectifying and AC-DC conversion properties to meet the requirement of LED light-emitting unit 10. The backup power supply 30 is a rechargeable battery used for charging/discharging. The backup power controller 40 contains a charging protection circuit, DC-DC circuit and timing control circuit, which are used to control the backup power supply 30 for automatic starting and timing control. After the main power supply 20 is shut off, the backup power supply 30 is activated automatically to provide the LED light-emitting unit 10 with timing power supply for time-delay lighting purpose.

Referring to FIG. 2, the removable linking structure indicates a pin-type integrated structure 70, namely, the pin of male socket is inserted into the pinhole of female socket for electrical connection. The pin of male socket and pinhole of female socket are separately arranged on the power panel 50 and LED light panel 60. By inserting the pin of male socket into the pinhole of female socket, the removable linking structure can be removed and replaced, thus improving the performance of the light-emitting module, and reducing the manufacturing cost with better industrial efficiency.

Additionally, the backup power supply 30 of the present invention is of a removable structure for subsequent removal and replacement. Moreover, the pins on the LED light panel 60 are arranged in parallel or perpendicularly, and threaded out of the end cap of the light for electrical connection.

1. A light emitting diode LED module with a time-delay lighting function, the module comprising:
an LED light-emitting unit; and
a power input circuit, connecting said LED light-emitting unit to a main power supply, backup power supply and backup power controller, wherein said backup power supply and LED light-emitting unit are connected in parallel; said main power supply having at least two circuits are formed at an output end, one circuit being connected with said LED light-emitting unit for power supply and lighting, the other circuit being connected with the backup power supply via the backup power controller, allowing for charging/discharging of the backup power supply.

2. The module defined in claim 1, wherein the LED light-emitting unit is comprised of LED light panel in series or parallel connection.

3. The module defined in claim 2, wherein the LED light panel is patterned with long, round, oval or polygonal patterns.

4. The module defined in claim 2, wherein the LED light panel is comprised of a single panel structure, or a superimposed structure.

5. The module defined in claim 1, wherein the main power supply, backup power supply and backup power controller are arranged on a power panel, said main power supply having an electromagnetic interference EMI circuit, full-bridge rectifying circuit and AC-DC control circuit, said backup power supply being comprised of a rechargeable battery, said backup power controller having a charging protection circuit, DC-DC circuit and timing control circuit, said power panel being connected to the light-emitting module via a removable link.

6. The module defined in claim 5, wherein the removable linking structure indicates a pin-type integrated structure, a pin of male socket being inserted into the pinhole of female socket for electrical connection.
